(19) United States
(12) Patent Application Publication
(10) Pub. No.: US 2024/0230904 A9
(43) Pub. Date: Jul. 11, 2024

(54) LASER TRACKER HAVING TWO MEASUREMENT FUNCTIONALITIES AND FMCW DISTANCE MEASUREMENT

(71) Applicant: LEICA GEOSYSTEMS AG, Heerbrugg (CH)

(72) Inventors: Marcel ROHNER, Heiden (CH); Alexandre PADUCH, Dübendorf (CH); Thomas LÜTHI, Aarau (CH)

(73) Assignee: LEICA GEOSYSTEMS AG, Heerbrugg (CH)

(21) Appl. No.: 18/278,799

(22) PCT Filed: Feb. 24, 2021
(86) PCT No.: PCT/EP2021/054595

§ 371 Date: Aug. 24, 2023

(51) Int. Cl. G01S 17/66; G01B 21/22; G01S 7/481; G01S 7/4911; G01S 7/497; G01S 17/42

(52) U.S. Cl. CPC G01S 17/66; G01B 21/22; G01S 7/4817; G01S 7/4818; G01S 7/4911; G01S 7/497; G01S 17/42

(57) ABSTRACT

The invention relates to a laser tracker for the industrial, coordinative position determination of a target, the laser tracker providing two measurement functionalities, namely a measurement functionality for measuring and tracking a cooperative, e.g. retroreflective, target and a measurement functionality for the e.g. scanning measurement of a target with diffuse scattering, wherein both measurement functionalities can be carried out and referenced to each other by means of the same optoelectronic distance measurement device.

The invention relates to a coordinate measuring device, in particular designed as a laser tracker, for the industrial coordinative position determination of a target using an optical distance measuring unit.

Laser trackers are used, for example, in industrial measurement, for example, for the coordinative position determination of points of a component such as a vehicle fuselage, for example, in the context of an inspection or for the progressive position monitoring (for example also velocity determination) of a moving machine part.

Such laser trackers are typically designed for a coordinative position determination of a retroreflective target point and for a progressive tracking of this target point by means of a tracking unit. A target point can be represented here by a retroreflecting unit (for example a corner cube prism), which is targeted using an optical measurement beam, typically a laser beam, generated by a radiation source of the tracking unit or by a distance meter of the laser tracker. The laser beam is reflected in parallel back to the laser tracker, wherein the reflected beam is detected using detection means of the tracking unit or the distance meter. An emission or reception direction of the beam is ascertained for this purpose, for example, by means of sensors for angle measurement, which are assigned to a deflection mirror or a targeting unit of the system. Moreover, a distance from the laser tracker to the target point is ascertained with the detection of the beam, for example, by means of time-of-flight or phase difference measurement, by means of optical interferometers, or by means of the Fizeau principle. The position coordinates of the target point are determined on the basis of the emission or reception direction and the distance.

In contrast, special laser trackers exist which enable scanning measurement of surface points, thus a determination of very many point coordinates on the surface of an object to be measured, which takes place in a comparatively short time. However, accuracy losses have to be accepted for this purpose in comparison to measuring retroreflective targets.

A generic laser tracker includes, for example, a beam deflection unit having a base, a support, and a beam emitting component, wherein the support is fastened rotatably around the first axis of rotation on the base and the beam emitting component is fastened rotatably around a second axis of rotation, essentially orthogonal to the first axis of rotation, on the support. The beam emitting component includes an exit and entry optical unit, which is shared, for example, for a distance measuring beam and a targeting beam, which are used, for example, for accurate angular position determination of the cooperative target and for tracking the target object. Alternatively, the beam emitting component can also include separate objectives for different beam components or a separate entry optical unit and a separate exit optical unit.

Typically, both the support and the beam emitting component are moved in a motorized manner for the two-dimensional alignment of the distance measuring beam or targeting beam on a target.

For example, laser trackers according to the prior art include a tracking surface sensor in the form of a position-sensitive detector (PSD) for progressive target tracking, wherein measurement laser radiation reflected at the target can be detected thereon. A PSD is to be understood in this context as a surface sensor operating in a locally analog manner, using which a focal point of a light distribution on the sensor surface can be determined very rapidly and with a high resolution. The output signal of the sensor is generated here by means of one or more photosensitive surfaces.

Routine laser trackers have gradually come to include an automated target acquisition and target tracking function as a standard feature for prisms used as the target reflector (ATR: “Automatic Target Recognition”). For this purpose, a separate ATR light source and a special ATR detector (for example a CCD surface sensor) sensitive to the wavelength of the ATR light source are routinely integrated in the laser tracker.

Alternatively or additionally, a manual, rough targeting of the target object can be carried out on the user side, for example, in that the target object is imaged and displayed by means of a targeting and/or overview camera arranged on the laser tracker on a user display of the laser tracker or on the display of a separate peripheral device (for example a data logger as a remote control).

To keep the target in the “coupled” state even during rapid and jerky movements of the target and not lose it from the field of view of the ATR detector, for example, a further camera can record images of the target and track movements of the target (or movements of objects moving together with the target) by means of image processing, and thus in case of losing the target from the “coupled” state, facilitate finding the retroreflector again and coupling the laser beam on the retroreflector again.

In addition, in modern tracker systems, a displacement of the received measurement beam from a zero position is ascertained on a fine targeting system, by means of which a position difference between the center of the retroreflector and the point of incidence of the laser beam on the reflector is determined and the alignment of the laser beam is corrected or readjusted in dependence on this deviation such that the offset on the fine targeting sensor is reduced, in particular is “zero”, so that the beam is aligned in the direction of the reflector center.

Laser trackers of the prior art include at least one distance meter for distance measurement, wherein it can be designed, for example, as an interferometer (IFN). Since such distance measuring units can only measure relative distance changes, so called absolute distance meters (ADM) are installed in current laser trackers in addition to interferometers. Such a combination of measurement means for distance determination is known, for example, from the product AT901 of Leica Geosystems AG. A combination of an absolute distance meter and an interferometer for distance determination using a HeNe laser is known, for example, from WO 2007/079600 A1.

US 2014/0226145 A1 discloses a laser tracker which can measure both a retroreflective target and also a natural (thus non-retroreflective) surface. For this purpose, the laser tracker includes a first absolute distance meter, which is designed as known for measurement to a retroreflector. In addition, the laser tracker includes a second absolute distance meter, which is designed for measurement to an object surface. The respective absolute distance meters do emit their measurement radiation through a single exit optical unit, but are each separate independent units. The necessity of providing two completely independent, separate absolute distance meters is complex in terms of production technology and therefore costly.

It is an object of the present invention to provide an improved laser tracker of the type mentioned at the outset.

One special object is in particular to provide a simplified and more compact structure of the distance measuring unit, wherein the measurement functionalities of the laser tracker are expanded at the same time, but the measurement accuracy of the previous measurement functionalities is maintained or increased.

These objects are achieved by the implementation of at least parts of the characterizing features of the independent claims. Features which refine the invention in an alternative or advantageous manner can be inferred from the dependent claims.

A first aspect of the invention relates to a laser tracker for the industrial coordinative position determination of a target object. The laser tracker includes an emitting unit having an emitting component rotatable around two axes of rotation, wherein the emitting component is configured for emitting a targeting beam defining a target axis and a distance measuring beam defining a distance measuring axis. The laser tracker furthermore includes an angle detector configured for detecting angle data with respect to a rotation of the emitting component around the two axes of rotation.

For example, the emitting unit includes a regulating unit and the laser tracker is configured to keep the emitting component aligned automatically on the target object by means of the regulating unit by rotation around the two axes of rotation, wherein the regulating unit determines, by means of the targeting beam emitted in the direction of a cooperative target of the target object, an alignment of the emitting component relative to the cooperative target. Thus, based on returning parts of the targeting beam, control data can be generated for adapting the alignment of the emitting component with respect to the two axes of rotation. An automatic adjustment of the alignment of the emitting component with respect to the two axes of rotation can then be carried out by means of the control data and thus the target axis can be aligned on the measurement point defined by the cooperative target of the target object.

Moreover, the laser tracker includes a distance measuring unit, configured for carrying out a distance measurement to the target object, in the scope of which the distance measuring beam is emitted from the emitting component in the direction of the target object and returning parts of the distance measuring beam are received.

The laser tracker can thus be used—for example by means of the targeting beam and the angle data—in order to determine an alignment of the emitting component relative to a cooperative target of the target object in order to derive coordinates of the target object in combination with the distance measurement to the target object.

For example, a passive reflection unit having defined reflection properties can be used as a cooperative target, for example, a steel ball having known dimensions or a retroreflector such as a cubic prism. In other words: In conjunction with the present application, the term “cooperative target” refers to a target which is provided especially for use in conjunction with a fine targeting process and, for example, target tracking. The cooperative target therefore “cooperates” with the laser tracker, for example, a fine targeting unit and/or tracking unit, in that it has clearly defined attributes such as special reflection properties, a known shape, or known dimensions, which are utilized by the laser tracker for the purposes of the fine targeting process and/or the tracking process.

The laser tracker is furthermore configured to carry out a calibration functionality for referencing the distance measuring axis and the target axis, including:
a target axis reference measurement, wherein target axis angle data for an alignment of the emitting component are assigned to a first target point by means of the angle detector when the target axis is aligned on the first target point by means of rotation of the emitting component around the two axes of rotation,
a distance measuring beam scan, wherein a scan of a reference object takes place, wherein a large number of different alignments of the emitting component with respect to the two axes of rotation are set and associated scanning distances to the reference object are assigned by means of the distance measuring beam and associated scanning angle data are assigned by means of the angle detector to the different alignments for the respective alignment of the emitting component around the two axes of rotation,
a generation of a geometrical model, for example, a point cloud or a grid model (often also designated as a mesh model, wireframe model, surface representation, or polygon network model), of the reference object by means of the scanning distances and the scanning angle data, and, based thereon, an identification of a predefined second target point provided by the reference object, and
a derivation of a spatial relationship between the distance measuring axis and referencing data describing the target axis in consideration of the target axis angle data, the scanning angle data, and a previously known spatial relationship between the first and the second target point.

Referencing is understood in this context as a determination of a relative geometrical alignment of the distance measuring axis with respect to the target axis, by which, for example, it is made possible that a point targeted by the distance measuring beam is uniquely assignable to a point targeted by the targeting beam. Furthermore, it is thus made possible, for example, that intentional targeting of an arbitrary point in space can be carried out both by the distance measuring beam and by the targeting beam. In a further example, the referencing can be used to adapt the distance measuring axis and the target axis to one another by means of a settable beam deflection element.

In particular, the calibration functionality according to the invention enables a laser tracker having two measurement functionalities to be provided, namely the so-called “classic” measurement (and tracking) of a cooperative, for example retroreflective, target and a, for example scanning, measurement on a diffusely scattering target, wherein the two measurement functionalities can be carried out by means of the same optoelectronic distance meter and are referenceable to one another. The space required in the beam deflection unit and the calibration and production expenditure can thus be reduced, for example.

In one embodiment, the laser tracker is configured such that the derivation of the reference data takes place based on the assumption that the spatial arrangement of the first and the second target point is fixed, in particular that the positions of the first and the second reference point in space are identical.

In a further embodiment, the laser tracker includes an automatic target search functionality for automatically finding the first target point and/or the reference object. According to this embodiment, the laser tracker is therefore capable of carrying out the target axis reference measurement and the distance measuring beam scanning automatically in the context of the calibration functionality, by means of assistance by the automatic target search functionality.

According to a further embodiment, the laser tracker is configured such that the identification of the second target point takes place based on the assumption that the reference object is formed at least partially spherically and the second target point corresponds to the sphere center point of a sphere defined by the at least partially spherical shape of the reference object.

A further aspect of the invention relates to a laser tracker for the industrial coordinative position determination of a target object. The laser tracker includes an emitting unit having an emitting component rotatable around two axes of rotation, wherein the emitting component is configured to emit a targeting beam defining a target axis and a distance measuring beam defining a distance measuring axis. Furthermore, the laser tracker includes an angle detector configured for detecting angle data with respect to a rotation of the emitting component around the two axes of rotation and a distance measuring unit configured for carrying out a distance measurement to the target object, in the context of which the distance measuring beam is emitted by the emitting component in the direction of the target object and returning parts of the distance measuring beam are received. The laser tracker can in turn be used, for example, by means of the targeting beam and the angle data, to determine an alignment of the emitting component relative to a cooperative target of the target object.

According to this aspect of the invention, the laser tracker is configured to carry out a calibration functionality for referencing the distance measuring axis and the target axis, including:
a target axis reference measurement, wherein target axis angle data for an alignment of the emitting component are assigned to a first target point by means of the angle detector when the target axis is aligned on the first target point by means of rotation of the emitting component around the two axes of rotation,
an intensity scan, wherein a scan of a reference object takes place, wherein a large number of different alignments of the emitting component with respect to the two axes of rotation are set and associated reception intensities of returning parts of the distance measuring beam are assigned by means of the distance measuring beam and associated scanning angle data are assigned by means of the angle detector to the different alignments for the respective alignment of the emitting component around the two axes of rotation,
an identification of a predefined second target point provided by the reference object on the basis of an intensity distribution of the reception intensities on the reference object, in particular by identifying a highlight of the reference object, and
a derivation of a spatial relationship between the distance measuring axis and referencing data describing the target axis in consideration of the target axis angle data, the scanning angle data, and a previously known spatial relationship between the first and the second target point.

For example, the laser tracker is configured such that the identification of the second target point takes place based on the assumption that the reference object is formed at least partially spherically and the second target point is assigned to a point on the sphere surface or the center of a sphere defined by the at least partially spherical shape of the reference object (in particular corresponds to this point). Thus, for example, the radius of the sphere defined by the at least partially spherical shape of the reference object is stored on the laser tracker, so that the referencing takes place in consideration of these previously known radius, wherein the identification of the predefined second target point can be carried out, for example, by identifying a highlight in the reception intensities.

In general, instead of the highlight, a target having an outstanding feature visible in the reception intensities can be used, for example, a high-contrast target, wherein a predefined point is unambiguously determinable by means of intensity measurement.

A further aspect of the invention relates to a laser tracker for industrial coordinative position determination of a target object. The laser tracker includes an emitting unit having an emitting component rotatable around two axes of rotation, wherein the emitting component is configured for emitting a targeting beam defining a target axis and a distance measuring beam defining a distance measuring axis. Furthermore, the laser tracker includes an angle detector configured for detecting angle data with respect to a rotation of the emitting component around the two axes of rotation and a distance measuring unit configured for carrying out a distance measurement to the target object, in the context of which the distance measuring beam is emitted from the emitting component in the direction of the target object and returning parts of the distance measuring beam are received.

According to this aspect of the invention, the laser tracker includes an optical coupling element configured for generating a common emitting path of the targeting beam and the distance measuring beam. Furthermore, in the emitting path of the targeting beam upstream of the optical coupling element, a first beam deflection element is arranged, configured for setting an emission direction of the targeting beam relative to the emitting component. Additionally or alternatively, in the emitting path of the distance measuring beam upstream of the optical coupling element, a second beam deflection element is arranged, configured for setting an emission direction of the distance measuring beam relative to the emitting component. Furthermore, the laser tracker is now configured here, in the context of the distance measurement, depending on a set distance to the target object, in particular depending on a set focus parameter with respect to a focusing of the distance measuring beam on the target object, to perform a setting of the first and/or the second beam deflection element, for example, based on referencing data for a referencing of the distance measuring axis and the target axis, which were determined by a calibration functionality as described above.

In particular, the laser tracker is configured such that the setting of the first and/or the second beam deflection element takes place in such a way that the distance measuring axis is coaxial or parallel to the target axis.

A large number of possible components are known in the prior art as optical beam deflection elements, for example, one or more adjustment wedges, a lens and/or mirror arrangement, and/or MEMS-based beam deflection (MEMS=micro-electromechanical system) can be used. Further possibilities are acousto-optical elements, liquid lens elements, crystals which generate index of refraction gradients due to an electrical field, etc.

For example, the distance measuring unit includes a settable focus unit, configured for setting a variable focus parameter for the focusing of the distance measuring beam on the target object, in particular wherein the settable focus unit is configured and arranged such that the optical path of the targeting beam is free from the effect of the focus unit. For example, the focus unit is arranged outside the optical path of the targeting beam, thus only in the optical path of the distance measuring beam.

In a further embodiment, the laser tracker is configured
to carry out a distance measuring beam scan or an intensity scan of the reference object from a first distance and a further distance measuring beam scan or a further intensity scan of a further reference or the same reference object from a second distance different from the first distance, wherein the distance measuring unit includes, for example, a settable focus unit for setting a variable focus parameter with respect to the focusing of the distance measuring beam and a first value of the focus parameter is set for the first distance and a second value of the focus parameter different from the first is set for the second distance,
to carry out a derivation of first referencing data for the distance measuring beam scan or the intensity scan from the first distance and a derivation of second referencing data for the further distance measuring beam scan or the further intensity scan from the second distance, and
to derive a compensation parameter or a parameter set of compensation parameters, for example at least three compensation parameters, for a referencing of the distance measuring axis and the target axis as a function of the distance, in particular the focus parameter, by means of consideration of the first and second referencing data.

A further aspect of the invention relates to a laser tracker for industrial coordinative position determination of a target object, including a support, an emitting component rotatable with respect to the support having a beam exit, and a distance measuring unit having a laser beam source arranged in the support and an optical fiber arrangement configured for fiber-guided feed of radiation of the laser radiation source into the emitting component.

The distance measuring unit is configured here for carrying out a distance measurement to the target object, in the context of which at least a part of the radiation is emitted via the beam exit and parts of the radiation returning from the target object are detected, wherein the distance measurement is based on the principle of a modulated continuous wave radar.

For this purpose, the laser beam source is configured to generate a first and a second laser radiation, wherein at least one of the two laser radiations is frequency modulated, wherein a frequency gradient of the first laser radiation is different from a frequency gradient of the second laser radiation at least in some time intervals, for example.

Furthermore, the laser tracker includes an optics arrangement arranged in the support, which is configured to split the first laser radiation into a first measurement radiation and a first reference radiation and to feed the first reference radiation into a reference interferometer arrangement. Furthermore, the optics arrangement is configured to split the second laser radiation into a second measurement radiation and a second reference radiation and to feed the second reference radiation into the reference interferometer arrangement.

The reference interferometer arrangement is used, for example, in order to ensure a characterization of the, for example, linear tuning of the respective laser radiation. The reference interferometer arrangement includes at least two arms for separately guiding parts of the first and/or second reference radiation, wherein one of the two arms is designed as a fiber-guided reference route, which can be temperature controlled and/or temperature stabilized, and the at least two arms are brought together again in a superposition section to generate a reference output radiation. The reference route can be temperature controlled, for example, in the meaning that the temperature is measurable and can be taken into consideration in the context of the distance measurement.

Alternatively or additionally, the temperature for the distance measurement is actively stabilized to keep the length of the reference route constant.

The first reference output radiation is then, for example, supplied to the emitting component via a single-mode fiber.

The laser tracker moreover includes a frequency shifter, for example, based on an acousto-optical modulator, wherein the frequency shifter is configured to split the first measurement radiation into a first emission radiation and a first local oscillator radiation frequency-shifted from the first emission radiation, and to split the second measurement radiation into a second emission radiation and a second local oscillator radiation frequency-shifted from the second emission radiation.

The optical fiber arrangement is configured for the fiber-guided feed of the first and the second emission radiation as well as the first and the second local oscillator radiation and, for example, the reference output radiation, into the emitting component, wherein for the distance measurement a part of the first and the second emission radiation is emitted via the beam exit of the emitting component toward the target object and parts of the first and the second emission radiation returning from the target object are detected and furthermore the parts of the first and/or the second emission radiation returning from the target object are superimposed with the first and/or the second local oscillator radiation, for example, in the emitting component, in order to derive the distance to the target object based thereon in the context of the distance measurement according to the principle of a modulated continuous wave radar.

Instead of a feed of the reference output radiation into the emitting component, the reference radiation could also be detected outside the emitting component and therefore solely corresponding electrical or digitized signals could be provided for the consideration in the distance measurement, for example, by means of feeding the signals to the emitting component. The reception signals detected in the emitting component or generated from emission and local oscillator radiations could also be transmitted in an electrical or digitized manner in the support.

For example, the optics arrangement is designed as a free space optical unit. This is advantageous, for example, for a compact construction.

In general, it can be advantageous, for example, if fewer fibers are led through the axis, since the space is tight and a mechanically strained fiber is a component having risk of failure and thermally and/or mechanically related changes of the fibers could corrupt the distance measurement.

In order to reduce the number of the fibers led through the axis, for example, the frequency shifter is arranged in the support in one embodiment, wherein the optics arrangement and the reference interferometer arrangement are configured such that the reference output radiation is generated by means of heterodyne radiation mixing using the frequency shifter or a further frequency shifter arranged in the support. Furthermore, the optics arrangement and the optical fiber system are configured such that in each case the first and the second emission radiation together and the first and the second local oscillator radiation together are fed via a common fiber of the emitting component, in particular wherein the two fibers are each embodied as polarization-maintaining fibers.

Furthermore, according to a further variant, for example, the influence of all fibers on the measurement distance could be directly measured and the influence on the distance measurement to the target object could be compensated accordingly. Accordingly, the emitting component in a further embodiment includes an internal control channel having a separate receiver, shielded from returning parts of the first or second emission radiation, for a separate distance measurement according to the principle of a modulated continuous wave radar. In the emitting component, a part of the first and/or second emission radiation and a part of the first and/or second local oscillator radiation are decoupled into the internal control channel here, and based thereon a separate distance measurement based on the internal control channel is carried out according to the principle of a modulated continuous wave radar in order to take into consideration thermally and/or mechanically related changes of the fibers of the optical fiber arrangement in the derivation of the distance to the target object.

In a further embodiment, the frequency shifter is arranged in the emitting component, wherein the laser tracker includes a further frequency shifter arranged in the support. The optics arrangement and the reference interferometer arrangement are configured here such that the reference output radiation is generated by means of heterodyne radiation mixing using the further frequency shifter arranged in the support. Furthermore, the optics arrangement and the optical fiber arrangement are configured such that the first and the second measurement radiation are fed via a common fiber, for example, a polarization-maintaining fiber, of the emitting component. For example, the splitting of the first and/or second laser radiation and the feed of the first and/or second reference radiation to the reference interferometer arrangement take place in free space in this case downstream of the further frequency shifter arranged in the support.

For example, the first and the second laser radiation are led through the further frequency shifter arranged in the support, wherein the first and the second measurement radiation correspond to radiation of the same order of the further frequency shifter arranged in the support. The first and/or the second measurement radiation, for example, are each especially based on a part of the first and/or the second laser radiation, which is free of a frequency shift by the further frequency shifter arranged in the support.

Alternatively, for example, the first and the second measurement radiation are decoupled upstream of the further frequency shifter arranged in the support and led past the further frequency shifter arranged in the support into the emitting component.

In a further embodiment, the frequency shifter is arranged in the emitting component, wherein the optics arrangement and the reference interferometer arrangement are configured such that the reference output radiation is generated by means of homodyne radiation mixing. The optics arrangement and the optical fiber arrangement are then configured such that the first and the second measurement radiation are fed via a common fiber, for example, a polarization-maintaining fiber, of the emitting component.

In a further embodiment, the optics arrangement and the reference interferometer arrangement are arranged jointly in a module housing separable from the laser tracker in one piece.

The arrangement of the module housing in the support, in particular wherein, for example, corresponding plug connections of the fibers of the optical fiber arrangement are also arranged in the vicinity of the module housing in the support, has the advantage, for example, that the sensitive optics arrangement and the reference interferometer arrangement including support fibers are easily replaceable, due to which, for example, the maintenance and repair expenditure can be reduced.

In a further embodiment, the reference interferometer arrangement includes a first and a second reference interferometer, which are configured to provide a first or a second partial radiation of the reference output radiation. The first reference interferometer includes for this purpose two arms for separately leading parts of the first reference radiation, wherein one of the two arms of the first reference interferometer is led via the reference route (which is fiber-guided and can be controlled in temperature and/or stabilized in temperature) and the two arms of the first reference interferometer are brought together again in the superposition section for generating the first partial radiation. The second reference interferometer includes two arms for separately leading parts of the second reference radiation, wherein one of the two arms of the second reference interferometer is led via a further reference route, which is fiber-guided and can be controlled in temperature and/or stabilized in temperature, and the two arms of the second reference interferometer are brought together again in the superposition section to generate the second partial radiation. In particular, the two arms of the first reference interferometer are separated from the two arms of the second reference interferometer.

The first and/or the second partial radiation are then each fed, for example, via a single-mode fiber of the emitting component.

In a further embodiment, the reference route and the further reference route are arranged in a common box, which can be controlled in temperature and/or stabilized in temperature. The electronic and structural expenditure for the temperature stabilization can thus be reduced, for example, and it is ensured that the two reference routes are subjected to the same conditions.

With heterodyne detection or with different sweep rates, instead of the use of two separately formed reference interferometers for the first and the second reference radiation, the laser tracker can alternatively also be configured to separate the interferometer output signal of a common interferometer algorithmically with respect to components of the first and the second reference radiation.

Accordingly, the reference interferometer arrangement includes a (for example single) reference interferometer, which includes two arms for separately leading parts of the first and the second reference radiation, wherein one of the two arms is led via the reference route and the two arms are brought together again in the superposition section. The optics arrangement is furthermore configured such that the first and the second reference radiation are brought together upstream of the reference interferometer and are fed jointly as parts of the same interferometer input radiation to the reference interferometer. The interferometer output radiation is then fed, for example, via a single-mode fiber of the emitting component, wherein the laser tracker is configured to algorithmically separate an interferometer output signal generated by the reference interferometer with respect to components of the first and the second reference radiation.

In a further embodiment, the optical fiber arrangement includes a fiber, which is only partially protected with tube, wherein the fiber partially protected with tube includes tube in a region of the feedthrough between support and emitting component.

The partial use of tube has the advantage, for example, that the mechanical strain of the fiber by the tube due to different coefficients of thermal expansion can thus be reduced. For example, the fiber only partially protected with tube is only protected with tube at locations having mechanical stress—caused by the operation of the laser tracker.

In a further embodiment, the emitting component includes an objective, two fiber collimators, a receiver, and two beam splitters, which are arranged in series on an arrangement axis parallel or coaxial to the optical axis of the objective and are polarizing, for example. The first and the second emission radiation are emitted via one of the two fiber collimators onto the beam splitter arranged axially closer to the objective, which is configured to deflect at least a part of the first and the second emission radiation axially in the direction of the objective. The first and the second local oscillator radiation are emitted via the other of the two fiber collimators onto the beam splitter arranged axially farther from the objective, which is configured to deflect at least a part of the first and the second local oscillator radiation axially in the direction of the receiver. The two beam splitters are configured to let through at least parts of the parts of the first and/or the second emission radiation returning from the target to the receiver.

The emitting component typically furthermore includes a quarter-wave retardation plate, which is arranged, for example, on the arrangement axis between the objective and the two beam splitters.

Furthermore, the emitting component can include an adjustable aperture in the optical path of the first and the second emission radiation.

In a further embodiment, the emitting component includes an attenuator, configured for the settable attenuation of the first and second emission radiation emitted from the one of the two fiber collimators, wherein the attenuator is arranged, for example, between the one of the two fiber collimators and the beam splitter arranged axially closer to the objective. For example, the attenuator is pivotable in and out of the optical path of the first and second emission radiation or is configured for the selectable setting of different attenuation factors (attenuation powers). For example, the attenuator is based on a fiber-coupled variable optical attenuator.

In a further embodiment, the emitting component includes, between each of the two fiber collimators and the respective assigned beam splitter, a beam deflection element configured for adapting the beam directions of the first and second emission radiation or the first and second local oscillator radiation.

A large number of possible components are known in the prior art as optical beam deflection elements, for example, adjustment wedges, lens and/or mirror arrangements, and/or MEMS-based beam deflection (MEMS=micro-electromechanical system), acousto-optical elements, liquid lens elements, crystals which generate index of refraction gradients due to an electrical field, etc.

In a further embodiment, the emitting component includes an at least partially reflective reference component and is configured to emit at least a part of the first and second emission radiation in free space onto the reference component and to take into consideration parts of the first and second emission radiation returning from the reference component in the context of the distance measurement.

Alternatively to the above-described optics and interferometer arrangements, a single constantly operated laser in combination with an electro-optical modulator arranged in the support could be used as the laser beam source (with RF generation). Such a structure for beam generation is described, for example, in European patent application 18 190 343.6. Only one fiber thus has to be led through the axis, wherein this fiber leads the side bands generated by the electro-optical modulator and to be used for the measurement radiation. To enable a heterodyne measurement, the frequency shifter is arranged, for example, in the emitting component in order to generate the first and second emission radiation and the first and second local oscillator radiation. The interferometrically measurable distance has its origin in the frequency shifter, due to which the fiber used for the axis feedthrough is thus not incorporated in the measurement distance. The above-mentioned fiber problems furthermore apply to the output fibers of the frequency shifter arranged in the emitting component, however, but are essentially reduced to thermal effects, since the mechanically changing axis feedthrough is eliminated.

A further aspect of the invention relates to a laser tracker for industrial coordinative position determination of a target object, including a support, an emitting component rotatable with respect to the support having a beam exit, and a distance measuring unit having a laser beam source arranged in the support and an optical fiber arrangement configured for the fiber-guided feed of radiation of the laser beam source into the emitting component. The distance measuring unit is configured to carry out a distance measurement to the target object, in the context of which at least a part of the radiation is emitted via the beam exit and parts of the radiation returning from the target object are detected.

According to this aspect, the laser beam source is configured for generating a frequency-modulated laser radiation and the laser tracker furthermore includes a frequency shifter, for example, based on an acousto-optical modulator, configured for splitting the laser radiation into an emission radiation and a local oscillator radiation frequency shifted in relation to the emission radiation. Furthermore, the laser tracker is configured to emit at least a part of the emission radiation via the beam exit of the emitting component toward the target object and to superimpose parts of the emission radiation returning from the target object and at least a part of the local oscillator radiation, in order to derive the distance to the target object according to the principle of a modulated continuous wave radar based thereon in the context of the distance measurement.

The emission component furthermore includes an at least partially reflective reference component and is configured to emit at least a part of the emission radiation in free space onto the reference component and to detect parts of the emission radiation returning from the reference component and to take into consideration these parts of the emission radiation returning from the reference component for the distance measurement to the target object.

For example, the laser tracker is configured to take into consideration the parts of the emission radiation returning from the reference component by way of a superposition of the parts of the emission radiation returning from the reference component with at least a part of the local oscillator radiation.

For example, the reference component is designed as a partially reflective lens, in particular as a meniscus lens. A disk or planar plate, or a back reflection at a beam splitter would also be conceivable, for example. In general, beam components not deflected in the direction of the target object could be detected and measured in a separate channel in the emitting component.

The reflection enables detection and compensation of remaining thermally or mechanically related changes of fiber lengths, which can thus be recognized in real time and compensated in the distance measurement. For example, the laser tracker is configured to compensate variations of a fiber length of a fiber used for the beam guiding of the emission radiation and/or local oscillator radiation, based on the assumption that the optical path of the emission radiation containing the fiber for the emission radiation should be constant to the reference component.

In particular with homodyne detection, the reflection at the reference component could be used directly as the local oscillator radiation, wherein the position of the reflection in particular corresponds to the zero point, for example. Alternatively, in particular with heterodyne detection, the reflection at the reference component is therefore rather used as an additional calibration.

In one embodiment, the emitting component includes an objective and a beam splitter, wherein the objective and the beam splitter are arranged in series on an arrangement axis parallel or coaxial to the optical axis of the objective, so that at least a part of the emission radiation is axially deflected in the direction of the objective via the beam splitter. Furthermore, the reference component is arranged in a static region between the objective and the beam splitter along the arrangement axis, wherein the static region is free of axially moving components of the emission component and is delimited by the beam splitter on the beam splitter side and wherein the beam splitter is configured to let through at least parts of the parts of the emission radiation returning from the reference component.

In a further embodiment, the area between the outermost optical component and the beam splitter furthermore includes a movable region having axially moving components, for example a focus unit.

In a further embodiment, at least a part of the emission radiation is deflected axially in the direction of the objective via the beam splitter and the beam splitter is configured to let through at least parts of the parts of the emission radiation returning from the target object.

In particular, the emitting component is designed as an emitting component rotatable around two axes of rotation and the laser tracker includes a regulation device, by means of which the emitting component is alignable in a motorized manner on the target object by rotation around the two axes of rotation.

Due to the use of the optics or measurement arrangement for a modulated continuous wave radar, a coordinate measuring device, for example, a laser tracker according to one of the embodiments described at the outset, can be furthermore expanded thanks to the occurrence of speckle patterns (often also referred to solely as speckle), for example, to provide a measurement of a rotation rate of a rotating target object, for example, a target object in intrinsic rotation.

If the target object is targeted, for example, using the distance measuring axis beyond the rotational axis of the target object, wherein the distance measuring beam is not parallel to the rotational axis, due to the occurrence of speckle patterns, a Doppler shift of the frequency of the distance measuring beam caused by the axial component of the rotational velocity of the target object at the point of incidence of the distance measuring axis on the target object can be observed. As described hereinafter, this can be utilized to derive the (instantaneous) rotation rate of the target object around the rotational axis.

In particular the two-axis arrangement of the emitting component enables simplified determinations of the rotational axis and the speed of the rotating target object in relation to the prior art, for example, by means of automatic measurement of the target object to determine the alignment of an end face of the rotating object penetrated by the rotational axis with respect to the rotational axis.

A further aspect of the invention relates to a coordinate measuring device for industrial coordinative position determination of a point in space, for example, designed as a laser tracker, including an emitting unit configured for setting the alignment of a measurement axis with respect to two axes of rotation. The coordinate measuring device includes a distance measuring unit having a laser beam source, wherein the distance measuring unit is configured to carry out a distance measurement, in the context of which at least a part of radiation generated using the laser radiation source is emitted via the emitting unit along the measurement axis into the space and returning parts of the radiation, designated as reception radiation, are detected. In this case, the distance measuring unit includes an optical arrangement for carrying out the distance measurement according to the principle of a modulated continuous wave radar (see, for example, coordinate measuring devices described at the outset). Furthermore, the coordinate measuring device includes an angle detector, configured for detecting angle data with respect to the alignment of the measurement axis around the two axes of rotation.

According to this aspect, the coordinate measuring device furthermore includes a rotation rate measurement functionality for determining a rotation rate of a target object rotating around a rotational axis, wherein the coordinate measuring device is configured to determine a Doppler shift with respect to a measurement direction along the measurement axis for a reception frequency of the reception radiation and to derive the rotation rate of the target object in consideration of a 6DoF position (6 degrees of freedom) of the rotational axis of the target object relative to the coordinate measuring device.

In one special embodiment, the rotation rate measurement functionality includes two steps, wherein in the context of a first step, an automatic Doppler measurement of the target object is carried out, including different alignments of the measurement axis with respect to the two axes of rotation and a determination of the Doppler shift for each of the different alignments. Based on the automatic Doppler measurement, an automatic determination of the 6DoF position of the axis of rotation of the target object relative to the coordinate measuring device is carried out, for example, under the assumption of a constant rotation rate of the target object during the first step. In the context of a second step, the (instantaneous) rotation rate can then be determined by aligning the measurement axis on a measurement point on the target object, wherein the measurement point has an offset away from the rotational axis, for example, wherein the coordinate measuring device derives a radial distance of the measurement point from the rotational axis on the basis of the 6DoF position of the rotational axis and takes it into consideration in the determination of the rotation rate.

For example, the coordinate measuring device is configured, in the context of the first and/or second step, to take into consideration geometry data which provide information with respect to the external shape of the target object.

Alternatively or additionally, the coordinate measuring device includes, for example, a further step, configured for automatic coordinative scanning of the target object and for determining geometry information with respect to an external shape of the target object, which is taken into consideration in the context of the first and/or second step. For example, the coordinative scanning is carried out by means of the distance measuring unit and multiple different alignments of the measurement axis with respect to the two axes of rotation and/or by means of a camera-based scanned by a camera of the coordinate measuring device, for example, based on the principle of stereophotogrammetry or strip projection. A 3D model of the target object, for example, a point cloud or a grid model, can thus be generated by the coordinative scanning and taken into consideration in the context of the first and/or second step.

Therefore, for example, movement components in the direction of the measurement axis, which result due to a non-planarity of the target object, can be taken into consideration or compensated. These include, for example, a nonideal alignment of the end face of the target object in relation to the rotational axis.

In a further embodiment, the coordinate measuring device is configured to carry out the distance measurement according to the principle of a dual chirp frequency modulation and thus to derive the distance as the absolute distance between the coordinate measuring device and the target object.

For example, the distance measuring unit is configured to generate a laser radiation and to split the laser radiation into an emission radiation and a local oscillator radiation, for example, wherein the distance measuring unit is configured to generate a frequency-modulated laser radiation and includes a frequency shifter for splitting the laser radiation into the emission radiation and the laser oscillator radiation, wherein the local oscillator radiation is frequency shifted in relation to the emission radiation. The distance measuring unit is designed here to emit at least a part of the emission radiation via the emitting unit along the measurement axis and to superimpose parts of the emission radiation returning from the target object with the local oscillator radiation.

In particular, the laser radiation source is configured to generate a further, typically frequency-modulated laser radiation, wherein, for example, at least in some time intervals a frequency gradient of the laser radiation is different from a frequency gradient of the further laser radiation. The Doppler shift can thus be determined in consideration of the further laser radiation.

In a further embodiment, the coordinate measuring device includes a segmented receiver for carrying out a speckle measurement functionality. The segmented receiver is configured to detect at least a part of the reception radiation, wherein the receiver includes multiple, in particular at least three reception surfaces readable separately from one another. A typical such segmented receiver is, for example, a quadrant detector, wherein the segments form four quadrants of a reception surface and the reception surfaces are located close to one another so that only a narrow gap lies in each case between adjacent quadrants. The speckle measurement functionality of the coordinate measuring device is configured for determining a speckle pattern of the reception radiation detected at a point in time by the receiver. The receiver is thus, for example, designed to at least partially resolve a speckle field. Furthermore, a determination of a profile of speckle patterns of the reception radiation determined at different points in time takes place in the context of the speckle measurement functionality, wherein the rotation rate is derived in consideration of the profile of the speckle patterns determined at the different points in time.

For example, the rotation rate is determined by searching for a repeating feature of the speckle pattern, especially a periodicity of the repeating feature. Theoretically, a movement direction could also be determined from the profile of the speckle patterns.

In one embodiment, the speckle measurement functionality is configured for determining a speckle centroid of the speckle pattern detected at a point in time by the receiver and for determining a profile of speckle centroids determined at different points in time of the speckle patterns generated at the different points in time. The rotation rate can thus be derived in consideration of the profile of the speckle centroids determined at the different points in time, for example, by determining a repeating pattern, especially a periodicity, of the speckle centroids.

Reference is made to EP 2 513 595 B1 for a description of the occurrence of speckles and their relevance in interferometric measuring devices. Furthermore, a possibility also known in the prior art is described in EP 2 513 595 B1, for example, in order to determine a speckle centroid using a segmented receiver, for example, a quadrant detector.

A further aspect of the invention relates to a coordinate measuring device for industrial coordinative position determination of a point in space, for example, designed as a laser tracker, including an emitting unit configured for setting the alignment of a measurement axis with respect to two axes of rotation. The coordinate measuring device includes a distance measuring unit having a laser beam source, wherein the distance measuring unit is configured to carry out a distance measurement, in the context of which at least a part of radiation generated using the laser radiation source is emitted via the emitting unit along the measurement axis into the space and returning parts of the radiation, designated as reception radiation, are detected. Furthermore, the coordinate measuring device includes an angle detector, configured for detecting angle data with respect to the alignment of the measurement axis around the two axes of rotation.

According to this aspect, the coordinate measuring device furthermore includes a segmented receiver and a speckle measurement functionality, wherein the segmented receiver is configured to detect at least a part of the reception radiation and includes multiple reception surfaces readable separately from one another, and the speckle measurement functionality is configured to determine a speckle pattern of the reception radiation detected by the receiver at a point in time and to determine a profile of speckle patterns of the reception radiation determined at different points in time.

In particular, the distance measuring unit includes an optical arrangement for carrying out the distance measurement according to the principle of a modulated continuous wave radar (see, for example, coordinate measuring devices described at the outset).

In one embodiment, the coordinate measuring device includes a rotation rate measurement functionality for determining a rotation rate of a target object rotating around a rotational axis, wherein the rotation rate is derived in consideration of the profile of the speckle patterns determined at the different points in time, for example, by determining a repeating feature of the speckle pattern, especially a periodicity of the repeating feature.

In one embodiment, the speckle measurement functionality is configured for determining a speckle centroid of the speckle pattern detected at a point in time by the receiver and for determining a profile of speckle centroids determined at different points in time of the speckle patterns generated at the different points in time, wherein the rotation rate is derived in consideration of the profile of the speckle centroids determined at the different points in time, for example, by determining a repeating pattern, especially a periodicity, of the speckle centroids.

The laser tracker according to the invention and the coordinate measuring device according to the invention as well as the various aspects of the invention are described in more detail solely by way of example hereinafter on the basis of exemplary embodiments schematically illustrated in the drawings. Identical elements are identified by identical reference signs in the figures. The described embodiments are generally not shown to scale and they are also not to be understood as a restriction.

### IN THE SPECIFIC FIGURES

FIG. 1: schematically shows a measuring system according to the prior art;

FIG. 2: shows an exemplary application of a laser tracker according to the present invention, including a first and a second measurement functionality;

FIG. 3: shows a schematic structure of a laser tracker having a target axis and a distance measuring axis;

FIG. 4: shows a laser tracker according to the invention during a measurement in the first measurement functionality for determining target axis angle data in the context of the calibration functionality;

FIG. 5: shows a laser tracker according to the invention during a measurement in the second measurement functionality for determining scanning distances and scanning angle data in the context of the calibration functionality;

FIG. 6: shows a first embodiment of an optical arrangement for a laser tracker according to the invention based on the principle of a modulated continuous wave radar;

FIG. 7: shows a second embodiment of an optical arrangement for a laser tracker according to the invention based on the principle of a modulated continuous wave radar;

FIG. 8: shows a third embodiment of an optical arrangement for a laser tracker according to the invention based on the principle of a modulated continuous wave radar;

FIG. 9: shows an optical emitting and receiving arrangement in the emitting component, as could be used, for example, in the embodiments shown in FIG. 6 and FIG. 8;

FIG. 10 shows an exemplary arrangement for the measurement of the rotation rate of a target object in intrinsic rotation using a coordinate measuring device including a rotation rate measurement functionality.

FIG. 1 schematically shows a measurement system according to the prior art for determining 3D coordinates of an object 100. The measurement system in this case includes a laser tracker 101 and a mobile scanning unit 2. A retroreflector 3 is attached to the scanning unit 2, which can be targeted by the laser tracker 101 by means of a laser beam 4 as a tracking or measuring beam, by which the position of the scanning unit 2 relative to the laser tracker 101 is determinable. Furthermore, laser trackers 101 according to the prior art presently increasingly include a camera (not shown) as a standard feature, so that by means of markings (not shown) attached to the scanning unit 2 and image processing of a camera recording of the scanning unit 2, its alignment can be determined. Moreover, a scanning beam 5 is emitted at the mobile scanning unit 2, using which the object surface is scanned and local measurement coordinates of the respective position of the surface are determined. By way of this arrangement, the measurement points thus measured on the object 100 can be referenced by means of the laser tracker 101 in an object coordinate system and global 3D coordinates of the object 100 can be generated.

Such measurement systems are used, for example, in industrial production in the measurement of, for example, aircraft or automobiles and can enable a quality control of workpieces accompanying the production.

The mobile scanning unit 2 is typically designed here as a handheld scanner or is mounted on a motorized movable articulated arm or robot, for example a UAV (“Unmanned Aerial Vehicle”). The scanning unit 2 typically has to be brought close to the object surface for measurement here, for example, less than 1 m. However, this is not always possible or is linked to effort, for example, in that with large overhanging objects, such as aircraft components in a manufacturing hall, while maintaining the required safety precautions to safeguard the worker, a ladder for a worker carrying the mobile scanner 2 has to be placed again progressively or in that the location of the measured object has to be progressively adjusted to the measuring task by means of a sometimes heavy device.

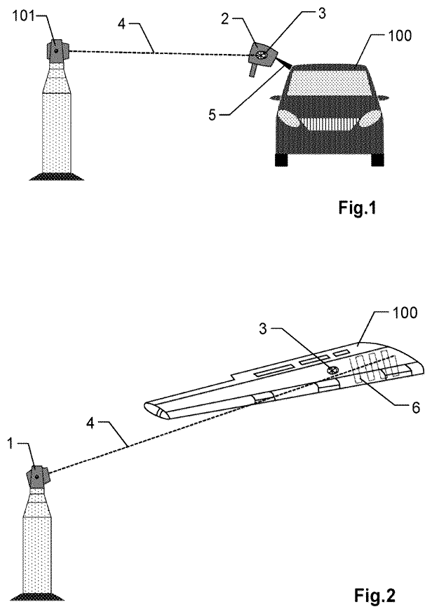

In contrast, FIG. 2 schematically shows a laser tracker 1 according to the present invention, for example, including a first and a second measurement functionality, wherein the first measurement functionality is designed for coordinative position determination of a cooperative, for example retroreflective, target 3 and the second measurement functionality is designed for coordinative position determination of a (essentially) diffusely scattering target, i.e., for scanning a natural surface of a target object 100, here, for example, an aircraft wing, and for generating a point cloud of the surface based on a number of scanning positions of the surface. The laser tracker 1 is configured here, for example, such that a movement of the laser beam 4 which is target tracking or follows a predetermined scanning pattern 6 is enabled.

For example, the laser tracker is configured in the second measurement functionality for carrying out a large number of distance measurements to a large number of diffusely scattering targets or target points on the surface of a target object to be measured. The laser tracker is configured here, for example, such that by means of a correspondingly designed control and evaluation unit, for example, rotational angles detected for the large number of distance measurements in each case using angle measurement means are linked to the measured distances, so that point positions of the respective target points are defined by the linkage, and a point cloud having a number of the point positions can be generated. This takes place, for example, at a rate of at least 100 point positions per second. For example, at least 1000 or at least 10 000 point positions are ascertained per second.

The first measurement functionality can thus be used, for example, for the generic tracking of a movable workpiece 100 equipped with retroreflectors 3 or for measuring individual specially labeled reference points equipped with retroreflectors 3 on the surface of the object 100. Furthermore, instead of the use of a mobile scanning unit 2 (see FIG. 1), it is possible to switch into the second measurement functionality to measure the surface of the target object 100, for example, referenced to a reference point measured in the first measurement functionality and marked with a retroreflector 3.

In contrast to a mobile scanning unit 2 used according to the prior art, by means of the laser tracker 1 according to the invention, the object surface can be scanned in the second measurement functionality over comparatively large distances, for example, over a few meters up to a few dozen meters, to generate a three-dimensional point cloud of the object surface.

The laser tracker according to the invention is configured to carry out the distance measurement in both measurement functionalities by means of the same optoelectronic distance meter, by which, for example, the space requirement in the beam deflection unit and the calibration and production expenditure can be reduced.

Various principles and methods are known for electro-optical distance measurement. One approach is to emit pulsed electromagnetic radiation, such as laser light, on a target to be measured and subsequently receive an echo from this target as a backscattering object, wherein the distance to the target to be measured can be determined, for example, on the basis of the time-of-flight, the shape, and/or the phase of the pulse. Such laser distance meters have gradually become widespread in many areas as standard solutions.

For example, the optoelectronic distance meter of the laser tracker according to the invention is designed for a distance measurement according to the pulse time-of-flight principle, wherein, for example, by means of scanning and sampling of the entire backscattered (and possibly emitted) pulse form, the entire signal form is detected (so-called “Waveform Digitizing”, WFD). An emitted pulse signal is detected in that the radiation detected by a detector is scanned, a signal is identified within the scanned region, and finally a location of the signal is determined with respect to time. A useful signal can also be identified under unfavorable conditions due to the use of a large number of scanning values and/or summation of the reception signal synchronous with the emission rate, so that greater distances or background scenarios which are noisy or subject to interference can also be managed.

Alternatively, the optoelectronic distance meter of the laser tracker according to the invention is designed, for example, for distance measurement according to the principle of a modulated continuous wave radar, also called FMCW distance measurement (FMCW: “Frequency Modulated Continuous Wave”).

A tunable laser source is used in an FMCW arrangement. In the embodiment which is simplest in principle, the tuning of the optical frequency of the laser source takes place linearly and at a known tuning rate here, wherein, however, the absolute wavelength of the signal thus generated is only known up to a certain degree. The radiation emitted toward the target is often called emission radiation or emission signal, wherein returning parts of the emission radiation are called reception radiation or reception signal. The reception radiation is superimposed with a second radiation, which is not emitted toward the target, but is derived from the laser radiation underlying the emitted emission radiation. The second radiation is often called local oscillator radiation. The resulting beat frequency of the mixed product, the interferogram, is a measure of the distance to the target.

The distance measuring devices used for implementing this method typically use a signal generator, by means of which a signal, for example, a rising or falling frequency ramp, is applied to a radiation source that can be modulated. In the optical area, lasers that can be modulated are usually used as radiation sources. Emitting and receiving optical units are used for emission and reception in the optical area, from which, for example, a detector for heterodyne mixing, an A/D converter, and a digital signal processor are connected downstream.

The change of the frequency of the emitted emission signal represents the scale of the measurement. Depending on the accuracy requirement for the distance measurement, this scale can be verified or determined more accurately by means of an additional measurement. A sufficiently linear tuning of the laser source often requires additional effort, for example. For this purpose, for example, a part of the emitted radiation is led via a reference interferometer having defined reference length. The frequency change over time of the emitted emission signal can be concluded from the resulting beat product on the basis of the known reference length. If the reference length is unknown or unstable, for example, due to temperature influences, this can be determined via an additional calibration unit, such as a gas cell or a Fabry-Perot element.

In the most favorable case, the target is a target resting relative to the distance meter, i.e., a target which has a distance unchanging over time to the distance meter. However, absolute distance measurements on moving or vibrating targets can also be carried out using suitable compensation measures.

A radial movement of the target relative to the distance meter results in a Doppler shift of the reception frequency due to the Doppler effect. The Doppler shift can be compensated, however, by a combined measurement by means of successive rising and falling frequency ramps, for example, since the Doppler shift is equal for both ramps in case of a constant radial velocity of the target, wherein the beat frequencies generated by the two ramps are different, however.

Two simultaneous and opposing frequency ramps are typically used, i.e., wherein radiation is emitted having to radiation components, wherein the frequency of a first radiation component is tuned “upward”, i.e., toward higher frequencies, and at the same time the frequency of a second radiation component is tuned “downward”, i.e., toward lower frequencies.

To be able to separate the radiation components metrologically, the laser tracker is configured, for example, for polarization-based, spectral-based, or algorithmic separations.

Such a measurement principle for a modulated continuous wave radar having two laser beams to compensate for the Doppler effect, wherein at least one of the two laser beams is frequency-modulated, is called the dual chirp frequency modulation principle or dual laser frequency modulation principle.

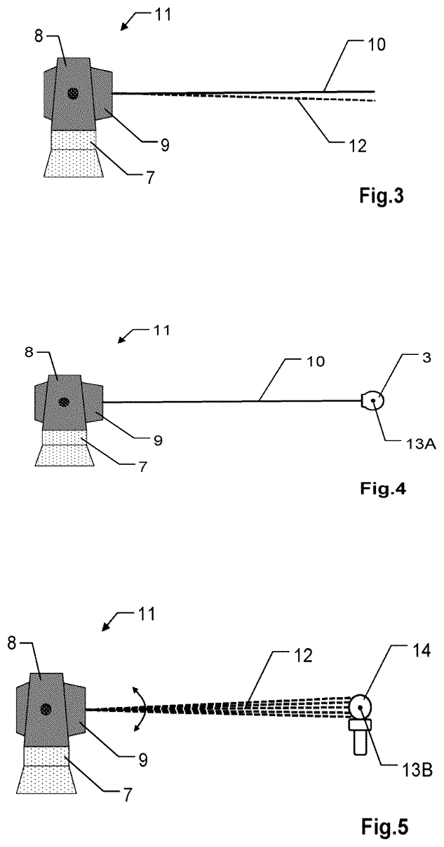

As schematically shown in FIG. 3, the laser tracker includes a base 7, a support 8, and an emitting component 9, wherein the support 8 is fastened rotatably around a first axis of rotation on the base 7 and the emitting component 9 is fastened rotatably around a second axis of rotation, essentially orthogonal to the first axis of rotation, on the support 8. The emitting component 9 includes an exit and entry optical unit, which is shared, for example, for a distance measuring beam and a targeting beam (often also used as a tracking beam, for example).

The base 7, support 8, and the emitting component 9 thus rotatable around two axes of rotation and defining a target axis 10 are often also jointly called the beam deflection unit 11. The laser tracker is configured to emit a targeting or tracking beam along the target axis 10 and to receive returning parts of the targeting or tracking beam. For the target tracking, for example, the laser tracker is configured to derive an angle position change of a cooperative target of the target object in relation to the laser tracker based on the tracking beam and to generate control data to adjust the alignment of the beam deflection unit 11.

Furthermore, the laser tracker includes a distance measuring unit, configured for determining a distance to the target object by means of emitting a distance measuring beam defining a distance measuring axis 12 via a beam exit of the emitting component 9 and detecting returning parts of the distance measuring beam.

The orientation or an orientation change of the beam deflection unit 11 is determined, for example, by means of an angle detector, which is configured to detect angle data with respect to a rotation of the beam deflection unit 11 around its two axes of rotation, i.e., to detect a rotation of the support 8 relative to the base 7 and a rotation of the emitting component 9 relative to the support 8.

In one exemplary embodiment, the emitting component 9 and thus the target axis 10 for target tracking are aligned such that a cooperative target, for example, a retroreflector 3 (see FIG. 1) or a so-called tooling ball is targeted by means of a tracking beam emitted from the emitting component 9 along the target axis 10.

Upon the use of a retroreflector 3 as a cooperative target, the tracking beam is reflected back to the emitting component 9 parallel to the target axis 10, wherein the reflected beam is detected using detection means of the beam deflection unit 11. An emission or reception direction of the tracking beam, thus a direction of the target axis 10, is ascertained in this case by means of the angle meters. For example, the receiver of the beam deflection unit is designed as a position sensitive detector (PSD), using which a focal point of a light distribution on the sensor surface can be determined very rapidly and with a high resolution. By means of the PSD, an offset of the received tracking beam from a zero position is ascertained and the alignment of the beam deflection unit 11, thus the alignment of the target axis 10, is progressively adjusted as a function of this offset so that the target axis 10 is aligned on the center of the retroreflector 3.

Furthermore, a distance measuring beam defining a distance measuring axis 12 is emitted from the emitting component 9 by means of the optical distance measuring unit to determine a distance to the target object.

The distance measuring unit and the beam deflection unit 11 are preferably configured and matched to one another such that the target directions defined by the target axis 10 and by the distance measuring axis 12 correspond precisely, i.e., exit coaxially from the emitting component 9. In this way, for example, a simplified referencing, which is direct in the best case (no computing effort), of position data of a measurement on a retroreflector (targeting beam or tracking beam defines target direction) with position data of a measurement on a diffusely scattering target (distance measuring beam defines target direction) is enabled.

The relative orientation of the two target directions in relation to one another can vary, however, due to aging and temperature influences and mechanical effects, for example. Variable optics components such as a focusing unit or a filter that can be pivoted in can also cause a deflection of the measuring axis.

For example, in the changeover from a measurement on a retroreflector to the measurement on a diffusely scattering target, a change of the focus setting of the distance measuring beam takes place from a focusing set essentially at infinity for measurement on retroreflectors to a distance-dependent focus setting for essentially sharp imaging of the diffusely scattering target object. The distance-dependent focus setting can be carried out, for example, by means of a focus unit settable for different distances or by means of a focus unit designed as a fixed focus unit, which provides a nominal focus. The focus unit is preferably part of the distance measuring unit here and is arranged in the laser tracker such that the focus unit does not act on the targeting or tracking radiation, i.e., the targeting or tracking radiation does not pass the focus unit. This focus changeover can now, however, result in different offsets of the distance measuring axis 12 from the target axis 10 for different measurement distances.

Furthermore, for example, adjustable attenuation filters are used in the emission channel of the distance measuring unit in order to adapt the emitted signal amplitude depending on the set measurement functionality to the electronic receiving unit, so that intensity differences of the returning radiation in measurements on retroreflective targets are compensated in relation to measurements on natural, diffusely scattering targets.

Since the direction is determined in both measurement functionalities based on the alignment of the emitting component 9 or the beam deflection unit 11, the laser tracker according to the invention is configured, for example, for carrying out a calibration functionality (schematically shown in FIGS. 4 and 5) for referencing the distance measuring axis 12 to the target axis 10.

As shown in FIG. 4, in the context of the calibration functionality, on the one hand, an alignment of the targeting beam, i.e., the target axis 10, on a first target point 13A, represented, for example, by a retroreflector 3 takes place and, for example, a determination of target axis angle data by means of the angle measuring means for the alignment of the target axis 10 defined by the alignment of the beam deflection unit 11 on the first target point 13A.

In a further step, the laser tracker, as shown in FIG. 5, carries out a scan of a reference object 14, for example, a so-called tooling ball, wherein the reference object 14 is scanned using the distance measuring beam by means of a movement of the support 8 and/or the beam deflection unit 9, wherein associated scanning distances to the target object and associated scanning angle data for the movement of the beam deflection unit are detected.

The laser tracker according to the invention is now configured to identify a predefined second target point 13B on the reference object 14 based on the scanning angle data and the associated scanning distances. Based thereon, the laser tracker derives referencing data for a referencing of the distance measuring axis 12 and the target axis 10, based on the target axis angle data and the scanning angle data and a previously known spatial relationship between the first target point 13A and the second target point 13B.

In other words: the angle data in the measurement on the retroreflector 3 are defined by the target axis 10, whereas the angle information is defined on the basis of the scan of the reference object 14 by the distance measuring axis 12, by which a referencing of the distance measuring axis 12 to the target axis 10 is enabled.

For example, to carry out the calibration functionality, first a retroreflector 3 and then a tooling ball 14 are placed such that the first target point 13A and the second target point 13B coincide.

The first target point 13A and/or the second target point 13B can be targeted or identified, for example, based on known geometric information, which provides shape information of a cooperative target or the reference object 14.

Alternatively or additionally to the determination of the target point position based on a spatial scan of the tooling ball 14, furthermore the highlight for emission radiation incident on the ball of the tooling ball 14 can be determined and used, for example, for deriving angle information with respect to the sphere center.

For example, the laser tracker is configured such that the shape information and/or the known spatial relationship between the first target point and the second target point is stored as reference information on the laser tracker or the laser tracker is configured to query and/or accept this reference information.

For example, a measurement sphere having known dimensions is used as the reference object, which is placed such that the sphere center corresponds to the second target point 13B or assumes a known relative position with respect to the second target point. For the first case, for example, it is sufficient if information is provided for the calibration functionality which is indicative of the ball radius, since the second target point 13B is linked directly to a uniquely defined parameter (sphere center) of the sphere.

It is self-evident that other shapes of the target object can also be used. The use of a (partial) sphere has the advantage, however, that with the sphere center point as the reference symmetrical to the sphere surface, no information about the orientation of the reference object 14 is required.

For example, a specially configured hollow calibration hemisphere could be used, which receives a retroreflector precisely in the sphere center, so that in the context of the calibration functionality of the laser tracker, the target axis reference measurement takes place on the basis of the retroreflector arranged in the calibration hemisphere and the calibration hemisphere only has to be rotated by 180° for the distance measuring beam scan or the intensity scan, so that the rear side of the calibration hemisphere is used as the reference object.

The targeting beam and/or the distance measuring beam are often emitted in wavelength ranges invisible to the human eye, for example in the infrared wavelength range. Generic laser trackers therefore often include a further pointing beam lying in the visible wavelength range, for example as an orientation aid for a user. Furthermore, such a pointing beam is also used, for example, for reasons of ocular safety upon the use of laser beams invisible to the human eye.

A further aspect of the invention relates to the targeting or tracking transmitter of a laser tracker described at the outset including a laser diode emitting in the visible wavelength range and the targeting or tracking radiation being provided in the visible wavelength range. The pointing beam is thus provided by a dual use of the targeting or tracking radiation, so that, for example, a further orientation or calibration of the pointing beam to the targeting or distance measuring beam is omitted.

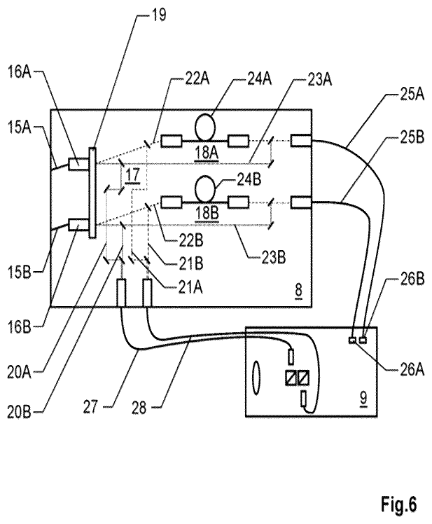

FIGS. 6 to 8 schematically show different embodiments of the optical arrangement of a laser tracker according to the invention based on the principle of a modulated continuous wave radar. As mentioned at the outset, by means of using the same optoelectronic distance meter for both measurement functionalities (measurement on cooperative targets versus measurement on diffusely scattering targets), for example, the space requirement in the support or the emitting component can be optimized and the calibration and production expenditure can be reduced. In principle, an FMCW distance meter is suitable both for measurement on cooperative targets and for measurement on (essentially) diffusely scattering targets.

The distance measurement is based here on two simultaneous opposing frequency ramps, wherein, for example, the frequency of a first radiation component is tuned “upward”, i.e., toward higher frequencies, and at the same time the frequency of a second radiation component is tuned “downward”, i.e., toward lower frequencies.

Accordingly, the laser tracker includes a laser beam source (not shown), configured for generating the first and the second frequency-modulated radiation, which are conducted, for example, in free space or, as shown in FIGS. 6 to 8, by means of two separate fibers 15A, 15B via respective fiber collimators 16A, 16B to a free space optics arrangement 18 arranged in the support 8.

In order to accurately characterize the tuning behavior of the two frequency ramps, for example, the laser tracker according to this aspect of the invention includes for each of the two frequency ramps a reference interferometer 18A, 18B arranged in the support, having a defined reference length in each case.

The various radiations or radiation components are then led via optical fibers from the support 8 into the emitting component 9.

In the embodiment shown in FIG. 6, the laser tracker includes a frequency shifter 19 arranged in the support 8, for example, an acousto-optical modulator. By means of the frequency shifter 19, the laser radiation coming from the laser radiation source and coupled in via two fiber collimators 16A, 16B is split into a part without frequency shift (unshifted part, dotted line) and into a part with frequency shift (frequency-shifted part, dashed line). The free space optics arrangement 17 then separates these radiation components further into measurement radiation and reference radiation, wherein the measurement radiation without frequency shift is used as the emission radiation 20A, 20B and the measurement radiation with frequency shift is used as the local oscillator radiation 21A, 21B.

The two reference interferometers 18A, 18B are each constructed as a heterodyne interferometer, wherein, for example, in each case the frequency-shifted reference radiation 22A, 22B covers a longer distance than the unshifted frequency radiation 23A, 23B, wherein in each case one arm here, for example, for the frequency-shifted reference radiation 22A, 22B is led via a fiber-guided reference route 24A, 24B, which can be temperature stabilized, for example, to generate an optical path difference of approximately 5 m. The two arms of the reference interferometer are subsequently superimposed and the superimposed signal is transferred into optical fibers 25A, 25B, for example, single-mode fibers. These fibers 25A, 25B thus already contain the radiation superimposed in the respective interferometer, because of which the exact fiber lengths have essentially no influence on the measurement result. These fibers 25A, 25B therefore also do not have to remain stable. For example, the superimposed reference radiations of the two reference interferometers are conducted onto corresponding reference receivers 26A, 26B arranged in the emitting component 9.

The two emission radiations 20A, 20B, to which opposing frequency ramps are applied, for example, are fed via a common fiber 27, for example a polarization-maintaining fiber, of the emitting component 9. Similarly, the two local oscillator radiations 21A, 21B are fed in a common fiber 28 of the emitting component 9.

In the example shown, the emission radiations 20A, 20B and the local oscillator radiations 21A, 21B are first brought into interference in the emitting component, wherein the local oscillator radiation 21A, 21B is emitted directly onto the receiver and the emission radiation 20A, 20B first runs to the target and back. The two fibers 27, 28 are thus part of the measuring route. If the length of the one to the other changes by dl, the distance to the target thus appears changed by dl/2. It therefore has to be ensured that the lengths of the fibers 27, 28 do not change in relation to one another as much as possible, or that the lengths change uniformly.

The arrangement of the laser beam source, free space optics arrangement 17, and the two reference interferometers 18A, 18B in the support 8 enables, for example, a more compact and simpler construction of the emitting component 9. However, the various radiations or radiation components have to be led via optical fibers from the support 8 into the emitting component 9. As long as emission radiation is not superimposed with the associated local oscillator radiation the individual optical fibers (waveguides) used for this feed, as described above, are still associated with the measuring route, however. Therefore, it has to be ensured that the fibers associated with the measuring route do not change in relation to one another as much as possible or that the fibers at least change uniformly. For this purpose, both fibers are typically equally long and are laid in parallel as much as possible. In the ideal case, both fibers are thus subjected to the same thermal (temperature) and mechanical (bending, pressure, torsion) conditions.

Identical fiber guiding is linked to a high control and stabilization effort, however, and, for example, in particular electrical cables in the axis feedthrough between support and emitting component can press differently on the fibers, due to which so-called microbends and local stress can arise. Furthermore, the “loose tubes” used to protect the fibers can pull and push on the fibers due to different coefficients of thermal expansion, wherein a so-called “stick-slip effect” can occur in rolled-up fibers, for example.

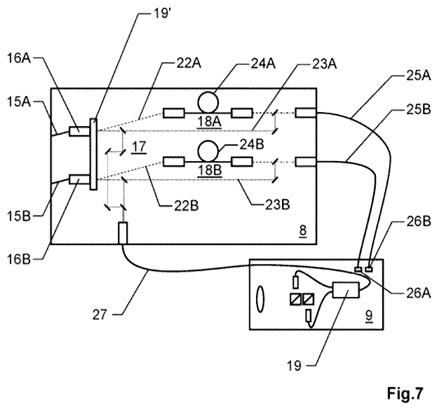

To reduce such temperature-related and mechanically-related influences due to the axis feedthrough on the measurement distance, in a further embodiment shown in FIG. 7, the laser tracker includes two frequency shifters 19, 19′, wherein one of the two frequency shifters for generating the emission radiation 20A, 20B and the local oscillator radiation 21A, 21B is arranged in the emitting component 9 and the other for providing the heterodyne reference interferometer 18A, 18B is still arranged in the support 8.

The free space optics arrangement 17 and the optical fiber arrangement are adapted such that only the parts which are not yet frequency shifted of the measurement radiations, to which opposing frequency ramps are applied, for example, are fed through a common fiber 27 of the emitting component 9. This eliminates, for example, the influence of the axis feedthrough on the measurement distance, wherein essentially, except for a synchronization of the frequency shifters, for example, no further adaptations are required on the optoelectronic layout and the data processing, however.

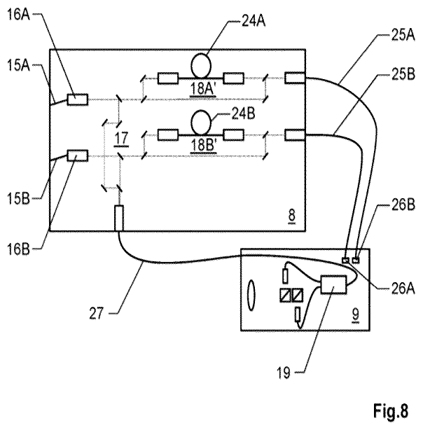

Alternatively, as shown in FIG. 8, the second frequency shifter can be omitted if the reference interferometers 18A′, 18B′ are designed as homodyne interferometers.

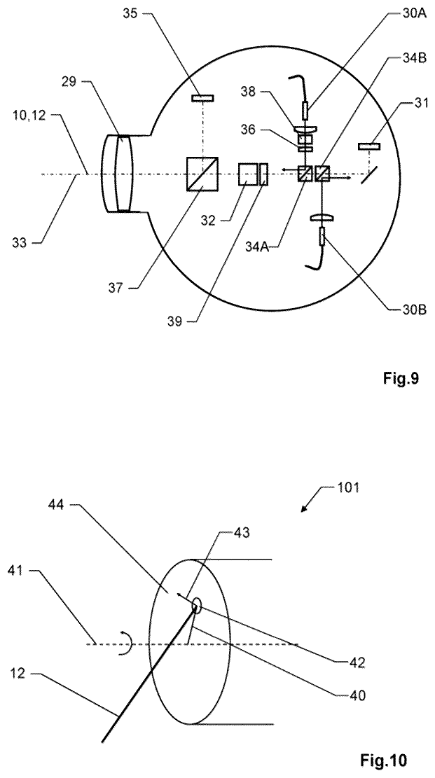

FIG. 9 shows an optical emitting and receiving arrangement in the emitting component, as could be used, for example, in the embodiments shown in FIG. 6 to FIG. 8.

The emitting component includes an objective 29, two fiber collimators 30A, 30B, a receiver 31, a focus arrangement 32, two beam splitters 34A, 34B arranged on an arrangement axis 33, coaxial to the optical axis of the objective here, and a laser source 35 for generating a targeting or tracking beam. Further components typically used for beam deflection or forming are also conceivable, such as partially transmissive or polarizing mirrors and retardation components, such as quarter-wave plates.

Furthermore, the laser tracker includes, for example, in the emission channel of the emission radiation, an adjustable attenuation filter 36, in order to adapt the emitted signal amplitude depending on the set measurement functionality at the receiver 31. Thus, for example, intensity differences of the returning radiation in measurements on retroreflective targets can be compensated in relation to measurements on natural, diffusely scattering targets.

The emission radiation is emitted via the beam splitter 34A arranged closer to the objective 29 in the direction of the target, whereas the local oscillator radiation is deflected by the beam splitter 34B farther from the objective directly onto the receiver 31.

As explained at the outset, it is typically advantageous if the laser tracker is configured such that the targeting beam is coupled by means of an optical coupling element 37 into the emission or reception path of the distance measuring beam, so that the distance measuring beam and the targeting beam exit essentially parallel or coaxial from the emitting component 9.

In particular, the laser tracker can include a calibration functionality as described at the outset, for referencing the distance measuring axis 12 and the target axis 10.

Furthermore, according to a further aspect of the invention, the laser tracker can be configured for an active compensation of relative orientation changes of the two target directions 10, 12 in relation to one another, for example in the case that the focus arrangement 32 is configured to set a variable focus parameter with respect to focusing of the distance measuring beam on the target object.

For the active compensation, the laser tracker includes, for example, in the emission path of the targeting beam upstream of the optical coupling element 37, a first beam deflection element, for example, one or more adjustment wedges, configured to set an emission direction of the targeting beam relative to the beam deflection unit (not shown), and/or the laser tracker includes, in the emission path of the emission radiation upstream of the optical coupling element 37, a second beam deflection element, for example, one or more adjustment wedges 38, configured to set an emission direction of the emission beam relative to the beam deflection unit. In the context of the determination of the distance, the laser tracker then performs a setting of the first and/or the second beam deflection element as a function of the focus parameter, for example, based on a compensation parameter determined according to the above calibration functionality for a focus-dependent or distance-dependent referencing of the distance measuring axis 12 and the target axis 10.

Alternatively or additionally, the laser tracker has, for example, access to a predefined lookup table having a list of focus-dependent compensation parameters.

The emitting component furthermore includes an at least partially reflective reference component 39, which reflects at least a part of the emission radiation before it exits from the emitting component, so that remaining thermally-related variations of the beam guiding of the emission radiation can thus be compensated for, for example, by analyzing a superposition of the parts of the emission radiation returning from the reference component 39 with a part of the local oscillator radiation and a comparison with a superposition of the parts of the emission radiation returning from the target object with a part of the local oscillator radiation.

For example, the reference component 39 is designed as a partially reflective lens, for example, as a meniscus lens, and is arranged between focus arrangement 32 and the beam splitter 34A for the emission radiation, so that, for example, no axially movable parts act on the emission radiation between reference component 39 and beam splitter 34A.

FIG. 10 shows an exemplary arrangement for measuring the rotation rate of a target object 101, which is in intrinsic rotation, using a coordinate measuring device including a rotation rate measurement functionality.

In the context of an inspection or for progressive position and velocity monitoring, a machine part 101 in intrinsic rotation is targeted. If the distance measuring axis 12 is aligned on a measurement point on the machine part 101, wherein the measurement point has a point distance (offset) 40 from the rotational axis 41 of the machine part 101 (and the distance measuring axis 12 is not parallel to the rotational axis 41), a Doppler shift, caused by the axial component, with respect to the distance measuring axis 12, of the rotational velocity of the machine part at the point of incidence 42, along the distance measuring axis 12 can be observed by the occurrence of speckles. The rotational velocity 43 at the point of incidence 42 of the machine part 101 around the rotational axis 41 is thus derivable.

If, for example, a segmented detector, for example, a quadrant detector, is used as a distance measuring detector, the determination of the movement direction and the rotation rate can take place without accurate knowledge of the geometry (location of the axis, rotation plane), since the centroid moves in the different segments periodically with respect to the rotation cycle of the workpiece 101.

If velocimeters used in the prior art have to have, for example, the geometry or the relative alignment of the measuring beam with respect to the end-face rotation plane 44 and the rotational axis 41 specified, the scanning functionality of a laser tracker 11 described at the outset, provided by the two-axis arrangement of the emitting component 9 (FIG. 3), enables the automatic determination of the geometry of the machine part 101. This enables a simplified, in particular automatic determination of the rotational axis 41 and thus the speed of the rotating machine part 101 without prior knowledge of the relative alignment of the distance measuring axis 12 with respect to the end-face rotation plane 44 and the rotational axis 41.

For example, the adjoining end face 44 can be coordinatively scanned and a 3D model can thus be created, for example, while the machine part is at rest. Information about the alignment of the end face 44 with respect to the distance measuring axis 12 and the geometry of the end face 44 is thus derived. The end face 44 is then scanned during the rotation of the machine part 101 and the Doppler shift is determined for different alignments of the distance measuring axis 12, by which, for example, a velocity map with respect to the rotation of the end face 44 around the rotational axis 41 is generated. Under the assumption that the machine part 101 rotates constantly, the penetration point of the rotational axis 41 with the target object can be determined via the zero velocity (no Doppler shift) and, in consideration of the distance measuring axis 12 and the geometry of the end face 44, the alignment of the rotational axis 41 and the rotational velocity 43 at the point of incidence 42 can be determined, for example, by renewed alignment of the distance measuring axis 12 on the point of incidence 42 with known radius 40.

It is apparent that these illustrated figures only schematically represent possible exemplary embodiments. The various approaches can also be combined with one another and with methods of the prior art.

1. A laser tracker for industrial coordinative position determination of a target object, including:
an emitting unit having an emitting component rotatable around two axes of rotation, wherein the emitting component is configured to emit a targeting beam defining a target axis and a distance measuring beam defining a distance measuring axis,
an angle detector configured for detecting angle data with respect to a rotation of the emitting component around the two axes of rotation, and
a distance measuring unit configured to carry out a distance measurement to the target object, in the context of which the distance measuring beam is emitted from the emitting component in the direction of the target object and returning parts of the distance measuring beam are received,
wherein the laser tracker is configured to carry out a calibration functionality for referencing the distance measuring axis and the target axis, including:
a target axis reference measurement, wherein target axis angle data for an alignment of the emitting component are assigned to a first target point by means of the angle detector when the target axis is aligned by means of rotation of the emitting component around the two axes of rotation on the first target point,
a distance measuring beam scan, wherein a scan of a reference object takes place, wherein a large number of different alignments of the emitting component with respect to the two axes of rotation are set and respective associated scanning distances to the reference object are assigned by means of the distance measuring beam and associated scanning angle data for the respective alignment of the emitting component around the two axes of rotation are assigned by means of the angle detector to the different alignments,
a generation of a geometrical model of the reference object by means of the scanning distances and the scanning angle data and, based thereon, an identification of a predefined second target point provided by the reference object, and
a derivation of referencing data describing a spatial relationship between the distance measuring axis and the target axis in consideration of the target axis angle data, the scanning angle data, and a previously known spatial relationship between the first and the second target point.

2. The laser tracker as claimed in claim 1, wherein the laser tracker is configured to provide the performance of the distance measurement in the scope of a first and a second measurement functionality, wherein:
in the first measurement functionality, the distance measurement takes place on a cooperative target, and
in the second measurement functionality, the distance measurement takes place on a diffusely scattering target.

3. The laser tracker as claimed in claim 1, wherein the laser tracker is configured such that the derivation of the referencing data is carried out based on the assumption that the spatial arrangement of the first and the second target point is fixed.

4. The laser tracker as claimed in claim 1, wherein:
the laser tracker includes an automatic target search functionality for automatically finding the first target point and/or the reference object, and
in the context of the calibration functionality, by means of assistance by the automatic target search functionality, the target axis reference measurement and the distance measuring beam scan take place automatically.

5. The laser tracker as claimed in claim 1, wherein the laser tracker is configured such that the identification of the second target point takes place based on the assumption that the reference object is formed at least partially spherically and the second target point corresponds to the sphere center point of a sphere defined by the at least partially spherical shape of the reference object.

6. A laser tracker for industrial coordinative position determination of a target object, including:
an emitting unit having an emitting component rotatable around two axes of rotation, wherein the emitting component is configured to emit a targeting beam defining a target axis and a distance measuring beam defining a distance measuring axis,
an angle detector configured for detecting angle data with respect to a rotation of the emitting component around the two axes of rotation, and
a distance measuring unit configured to carry out a distance measurement to the target object, in the context of which the distance measuring beam is emitted from the emitting component in the direction of the target object and returning parts of the distance measuring beam are received, wherein the laser tracker is configured to carry out a calibration functionality for referencing the distance measuring axis and the target axis, including:
a target axis reference measurement, wherein target axis angle data for an alignment of the emitting component are assigned to a first target point by means of the angle detector when the target axis is aligned by means of rotation of the emitting component around the two axes of rotation on the first target point,
an intensity scan, wherein a scan of a reference object takes place, wherein a large number of different alignments of the emitting component with respect to the two axes of rotation are set and respective associated reception intensities of returning parts of the distance measuring beam are assigned by means of the distance measuring beam and associated scanning angle data for the respective alignment of the emitting component around the two axes of rotation are assigned by means of the angle detector to the different alignments,
an identification of a predefined second target point provided by the reference object on the basis of an intensity distribution of the reception intensities on the reference object, and
a derivation of referencing data describing a spatial relationship between the distance measuring axis and the target axis in consideration of the target axis angle data, the scanning angle data, and a previously known spatial relationship between the first and the second target point.

7. The laser tracker as claimed in claim 6, wherein the laser tracker is configured such that the identification of the second target point takes place based on the assumption that the reference object is formed at least partially spherically and the second target point is assigned to a point on the sphere surface or the center of a sphere defined by the at least partially spherical shape of the reference object.

8. A laser tracker for industrial coordinative position determination of a target object, including:
an emitting unit having an emitting component rotatable around two axes of rotation, wherein the emitting component is configured to emit a targeting beam defining a target axis and a distance measuring beam defining a distance measuring axis,
an angle detector configured for detecting angle data with respect to a rotation of the emitting component around the two axes of rotation,
a distance measuring unit configured to carry out a distance measurement to the target object, in the context of which the distance measuring beam is emitted from the emitting component in the direction of the target object and returning parts of the distance measuring beam are received, and
an optical coupling element configured for generating a common emission path of the targeting beam and the distance measuring beam, wherein:
a first beam deflection element is arranged in the emission path of the targeting beam upstream of the optical coupling element, configured to set an emission direction of the targeting beam relative to the emitting component, and/or
a second beam deflection element is arranged in the emission path of the distance measuring unit upstream of the optical coupling element, configured to set an emission direction of the distance measuring beam relative to the emitting component, wherein the laser tracker is configured, in the context of the distance measurement, to perform a setting of the first and/or the second beam deflection element depending on a set distance to the target object.

9. The laser tracker as claimed in claim 8, wherein the laser tracker is configured such that the setting of the first and/or the second beam deflection element takes place in such a way that the distance measuring axis is coaxial or parallel to the target axis.

10. The laser tracker as claimed in claim 8, wherein the distance measuring unit includes a settable focus unit, configured for setting a variable focus parameter for the focusing of the distance measuring beam on the target object, wherein the settable focus unit is configured and arranged such that the optical path of the targeting beam is free of the effect of the focus unit.

11-43. (canceled)

44. The laser tracker as claimed in claim 1, wherein
the laser tracker comprises an optical coupling element configured for generating a common emission path of the targeting beam and the distance measuring beam,
a first beam deflection element is arranged in the emission path of the targeting beam upstream of the optical coupling element, configured to set an emission direction of the targeting beam relative to the emitting component, and/or
a second beam deflection element is arranged in the emission path of the distance measuring unit upstream of the optical coupling element, configured to set an emission direction of the distance measuring beam relative to the emitting component, and
the laser tracker is configured, in the context of the distance measurement, to perform a setting of the first and/or the second beam deflection element depending on a set distance to the target object, wherein:
the laser tracker is configured to provide the setting of the first and/or the second beam deflection element based on the referencing data describing a spatial relationship between the distance measuring axis and the target axis.

45. The laser tracker as claimed in claim 1, wherein the laser tracker is configured to:
carry out the distance measuring beam scan of the reference object from a first distance and a further distance measuring beam scan of a further reference object or the same reference object from a second distance different from the first distance, wherein the distance measuring unit includes a settable focus unit for setting a variable focus parameter with respect to the focusing of the distance measuring beam and a first value of the focus parameter is set for the first distance and a second value of the focus parameter, different from the first, is set for the second distance,
carry out a derivation of first referencing data for the distance measuring beam scan from the first distance and a derivation of second referencing data for the further distance measuring beam scan from the second distance, and
derive a compensation parameter for a referencing of the distance measuring axis and the target axis as a function of the distance, by means of consideration of the first and the second referencing data.

46. The laser tracker as claimed in claim 6, wherein:
the laser tracker comprises an optical coupling element configured for generating a common emission path of the targeting beam and the distance measuring beam,
a first beam deflection element is arranged in the emission path of the targeting beam upstream of the optical coupling element, configured to set an emission direction of the targeting beam relative to the emitting component, and/or
a second beam deflection element is arranged in the emission path of the distance measuring unit upstream of the optical coupling element, configured to set an emission direction of the distance measuring beam relative to the emitting component, and
the laser tracker is configured, in the context of the distance measurement, to perform a setting of the first and/or the second beam deflection element depending on a set distance to the target object, wherein the laser tracker is configured to provide the setting of the first and/or the second beam deflection element based on the referencing data describing a spatial relationship between the distance measuring axis and the target axis.

47. The laser tracker as claimed in claim 6, wherein the laser tracker is configured to:
carry out an intensity scan of the reference object from a first distance and a further intensity scan of a further reference object or the same reference object from a second distance different from the first distance, wherein the distance measuring unit includes a settable focus unit for setting a variable focus parameter with respect to the focusing of the distance measuring beam and a first value of the focus parameter is set for the first distance and a second value of the focus parameter, different from the first, is set for the second distance,
carry out a derivation of first referencing data for the intensity scan from the first distance and a derivation of second referencing data for the further intensity scan from the second distance, and
derive a compensation parameter for a referencing of the distance measuring axis and the target axis as a function of the distance, by means of consideration of the first and the second referencing data.

48. The laser tracker as claimed in claim 3, wherein the derivation of the referencing data is carried out based on the assumption that the positions of the first and the second target point in space are identical.

49. The laser tracker as claimed in claim 7, wherein the derivation of the referencing data takes place in consideration of a previously known radius of the sphere defined by the at least partially spherical shape of the reference object.

50. The laser tracker as claimed in claim 44, wherein the laser tracker is configured to provide setting of the first and/or the second beam deflection element depending on a set focus parameter with respect to a focusing of the distance measuring beam on the target object.

51. The laser tracker as claimed in claim 45, wherein the laser tracker is configured to derive the compensation parameter for the referencing of the distance measuring axis and the target axis as a function of the focus parameter, by means of consideration of the first and the second referencing data.

52. The laser tracker as claimed in claim 46, wherein the laser tracker is configured to provide setting of the first and/or the second beam deflection element depending on a set focus parameter with respect to a focusing of the distance measuring beam on the target object.

53. The laser tracker as claimed in claim 47, wherein the laser tracker is configured to derive the compensation parameter for the referencing of the distance measuring axis and the target axis as a function of the focus parameter, by means of consideration of the first and the second referencing data.
